(19) United States
(12) Patent Application Publication
(10) Pub. No.: US 2014/0357204 A1
(43) Pub. Date: Dec. 4, 2014

(54) Signal Processing

(71) Applicant: Broadcom Corporation, Irvine, CA (US)

(72) Inventors: Jari Johannes HEIKKINEN, Helsinki (FI); Juhani Kalervo AALTO, Espoo (FI)

(73) Assignee: Broadcom Corporation, Irvine, CA (US)

(21) Appl. No.: 14/291,309

(22) Filed: May 30, 2014

(30) Foreign Application Priority Data
Jun. 3, 2013 (GB) 1309886.8

(51) Int. Cl. H04B 1/04; H04B 1/62

(52) U.S. Cl. CPC H04B 1/0458; H04B 1/62; H04B 2001/045
USPC 455/114.3

(57) ABSTRACT

Apparatus, methods and methods of manufacture are provided for the processing of a current mode signal. A first signal processing stage comprising at least one output terminal is configured to produce a current mode output signal. A mutual inductance stage is arranged to inductively couple the at least one output terminal of the first signal processing stage to at least one input terminal of a second signal processing stage, wherein an input signal is generated at the at least one input terminal of the second signal processing stage on the basis of the current mode output signal produced at the at least one output terminal of the first signal processing stage.

### TECHNICAL FIELD

The present invention relates to signal processing systems, and in particular, but not exclusively, to apparatus and methods for the processing of current mode signals in radio frequency transmitter systems.

### BACKGROUND

In signal processing systems, such as those used in radio frequency transceiver applications, various transformations are applied to one or more input signals to produce a desired one or more output signals. Depending on the intended application, it may be important to maintain certain signal characteristics throughout the signal processing. One such desirable characteristic is linearity, which describes the degree to which one or more input signals are directly proportional to one or more corresponding output signals. Another desirable characteristic of signal processing systems is the ability to maintain a high signal to noise ratio (SNR). These two characteristics of signal processing systems are particularly relevant to radio frequency transceiver applications

A known method for achieving the above two desirable characteristics is to use so-called “current mode” design, wherein at least a majority of the signal information is encoded in the current, as opposed to the voltage of a signal. Current mode techniques allow for relatively easy pre-distortion of the input signal in the analogue domain, which facilitates compensation for non-linearity in the signal processing system. However, the use of current mode signals has the potential to produce high signal currents during the signal processing. High signal currents can cause high voltage signals to be generated between signal processing stages if they are driven into relatively high impedance nodes. Generation of high voltage signals during the signal processing can lead to signal distortion, which is detrimental to the desired linearity of the signal processing system.

In order to prevent high signal currents from producing high voltage levels during the signal processing, the signals may be driven into low impedance nodes in order to attenuate the voltage level of the signal. Such attenuation is typically achieved through the use of a low resistance value resistor, arranged in parallel with the node to be driven. However, low value resistors are inherently noisy components, and therefore detrimental to the SNR characteristics of the signal processing system. Further, this attenuation of the signal means that the gain of subsequent amplification stages must be increased in order to produce an output signal of the same magnitude. This is contrary to established principles of gain/noise partitioning and means that the effect of noise from early processing stages has an increased effect on the output signal, further degrading the SNR characteristics of the processing system.

FIG. 1 shows an example known circuit topology for signal processing in the context of a transmitter system. The circuit of FIG. 1 includes multiple signal processing stages, including a current mode modulation stage 104, which is configured to process input signal IN to generate a current mode output signal. Input signal IN is supplied via input terminal 102, and may include one or more baseband signals and one or more local oscillator signals. The output of current mode modulation stage 104 is driven into the input of the amplification stage 108. The input impedance of amplification stage 108 is influenced by impedance 106. Conventionally, impedance 106 may include an LC resonator (i.e. comprising an inductance and a capacitance) which acts as a frequency dependent load. As described above, the impedance of impedance 106 can be reduced by including a low value resistor in parallel with the LC resonator. The output OUT of amplification stage 108 is produced across impedance 110 at output terminal 112.

FIG. 2 illustrates schematically an example known circuit layout for the topology depicted in FIG. 1. The current mode modulation stage includes a transistor cascode arrangement, including transistors 202, 204 and 206. The input signal IN includes local oscillator input signal LO which is applied to transistor 202 via input terminal 102a, and baseband input signal BB which is applied to transistor 204 via input terminal 102b. Biasing voltage Vb1 is applied to transistor 206 via input terminal 208. The output of the current mode modulation stage is applied to the amplification stage via coupling capacitor 210.

The amplification stage includes a common-source driver arrangement, including transistors 212 and 214 and degradation impedance 216. Biasing voltage Vb2 is applied to transistor 214 via input terminal 218. The output signal of the amplification stage is produced across impedance 110 at output terminal 112.

In order to achieve a high signal to noise ratio, large signal currents are generated at the output of the current mode modulation stage. When driven into the impedance 106, large voltages are therefore generated at the input of the amplification stage 110. In turn, this leads to a high distortion term at the output 112 of the amplification stage. Attenuation of the output of the current mode amplification stage 104, for example through use of a parallel resistive component in impedance 106, would degrade the SNR of the system both by directly introducing an additional noise source and by requiring higher gain from the amplification stage 108, thereby further amplifying the noise from the current mode modulation stage 104. A further drawback of the prior art arrangements depicted in FIGS. 1 and 2 is that they require relatively high supply voltages (Vdd_mod and Vdd_drv) due to the number of transistors and impedances arranged in series.

It should be noted that all of the transistors illustrated in the known circuit arrangement of FIG. 2 are of the N-type metal oxide semiconductor (NMOS) variety. A known technique for overcoming the relatively large supply voltage requirement of cascode arrangements such as the one depicted in FIG. 2 is to utilise the technique of cascode folding.

FIGS. 3a and 3b illustrate possible examples of such folded cascode arrangements. Cascode folding involves exchanging one or more of the previously illustrated NMOS transistors for P-type metal oxide semiconductor (PMOS) devices. In the folded circuit shown in FIG. 3a, the NMOS transistors forming the amplification stage have been replaced by PMOS transistor 300. In the alternative folded circuit shown in FIG. 3b, the NMOS transistors forming the current mode modulation stage have been replaced by PMOS transistors 302, 304, and 306. Such cascode folding techniques can be utilised to reduce the total number of transistors and impedances that are required to be arranged in series. However, PMOS devices themselves have properties that are undesirable for achieving the characteristics of processing systems described previously. For example, PMOS devices are known to introduce noise into the signal processing system, as well as being undesirably large devices that also suffer from component ageing.

Hence, it would be desirable to provide a solution to one or more of the problems that have been identified above in relation to these known systems.

### BRIEF DESCRIPTION OF THE DRAWINGS

FIG. 1 shows a known circuit topology for signal processing;

FIG. 2 illustrates schematically a known circuit layout;

FIGS. 3a and 3b illustrate known folded cascode arrangements;

FIG. 4 shows a circuit topology according to embodiments of the present disclosure;

FIG. 5 illustrates schematically a circuit layout according to embodiments of the present disclosure;

FIG. 6 shows a further circuit topology according to embodiments of the present disclosure;

FIG. 7 illustrates schematically a circuit layout according to embodiments of the present disclosure;

FIG. 8 shows a yet further circuit topology according to embodiments of the present disclosure;

FIG. 9 shows a tracking arrangement according to embodiments of the present disclosure;

FIG. 10 shows a further tracking arrangement according to embodiments of the present disclosure; and

FIG. 11 shows a logic flow diagram illustrating a method according to embodiments of the present disclosure.

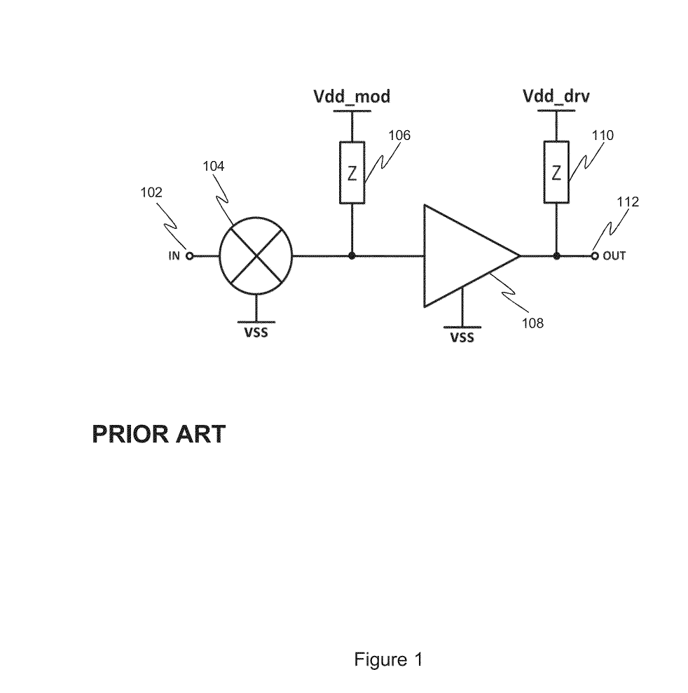

### DETAILED DESCRIPTION

According to first aspects, there is provided apparatus arranged to process a current mode signal in a radio frequency transmitter, the apparatus comprising:
a first signal processing stage comprising at least one output terminal, the first signal processing stage being configured to produce a current mode output signal at the at least one output terminal;
a second signal processing stage comprising at least one input terminal; and
a mutual inductance stage, arranged to inductively couple the at least one output terminal of the first signal processing stage to the at least one input terminal of the second signal processing stage,
wherein an input signal is generated at the at least one input terminal of the second signal processing stage on the basis of the current mode output signal produced at the at least one output terminal of the first signal processing stage.

According to second aspects, there is provided a method of processing a current mode signal in a radio frequency transmitter, the method comprising:
producing a current mode output signal at least one output terminal of a first signal processing stage;

inductively coupling the at least one output terminal of the first signal processing stage to at least one input terminal of a second signal processing stage via a mutual inductance stage; and
generating an input signal at the at least one input terminal of the second signal processing stage on the basis of the current mode output signal produced at the at least one output terminal of the first signal processing stage.

According to third aspects, there is provided a method of manufacturing an apparatus arranged to process a current mode signal in a radio frequency transmitter, the method comprising:
providing a first signal processing stage comprising at least one output terminal, the first signal processing stage being configured to produce a current mode output signal via the at least one output terminal;
providing a second signal processing stage comprising at least one input terminal; and
providing a mutual inductance stage, arranged to inductively couple the at least one output terminal of the first signal processing stage to the at least one input terminal of the second signal processing stage,
wherein an input signal is generated at the at least one input terminal of the second signal processing stage on the basis of the current mode output signal produced at the at least one output terminal of the first signal processing stage.

Further features and advantages of the invention will become apparent from the following description of preferred embodiments of the invention, given by way of example only, which is made with reference to the accompanying drawings.

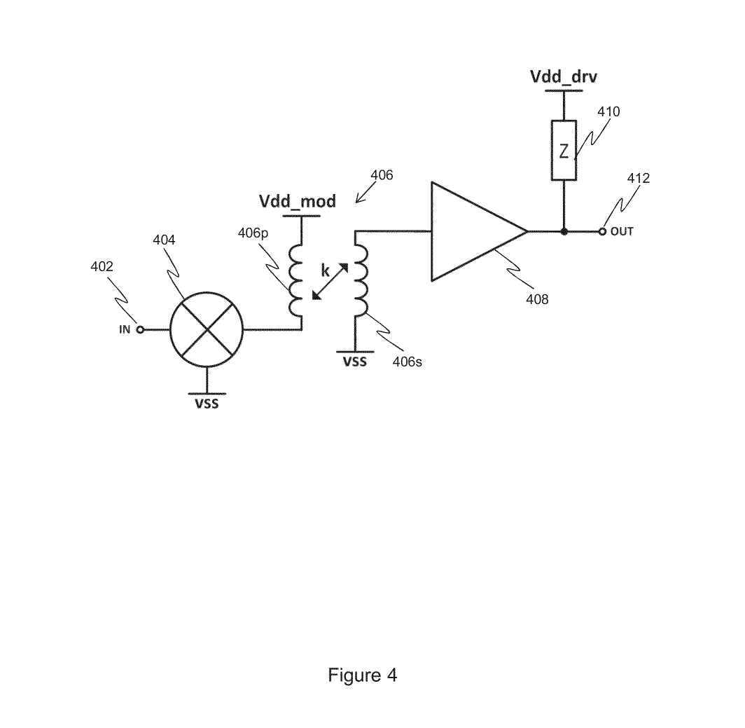

FIG. 4 shows an example circuit topology according to embodiments of the present disclosure for signal processing in the context of a radio frequency transmitter system. The circuit of FIG. 4 includes multiple signal processing stages, including a current mode modulation stage 404, which is configured to process input signal IN to generate a current mode output signal at an output terminal of the current mode modulation stage 404. Input signal IN is supplied via input terminal 402, and may include one or more baseband signals and one or more local oscillator signals (not shown). The output of current mode modulator 404 is driven into mutual inductance stage 406, which is arranged to inductively couple the output terminal of the first signal processing stage (in this case current mode modulation stage 404) to an input terminal of the second signal processing stage (in this case amplification stage 408). Amplification stage 408 is configured to produce an output signal OUT at output terminal 412 across impedance 410.

The circuit depicted in FIG. 4 is arranged such that an input signal is generated at the input terminal of the amplification stage on the basis of the current mode output signal produced at the output terminal of the current mode modulation stage. Use of mutual inductance stage 406 enables a current mode signal with a high signal to noise ratio to be generated at the output of a first signal processing stage (in this case a current mode modulation stage) without generating high voltages at the input to the subsequent signal processing stage (in this case an amplification stage).

In embodiments, the input terminal of the second signal processing stage comprises a low input impedance. According to embodiments, mutual inductance stage 406 comprises at least one primary portion 406p, and at least one secondary portion 406s, each of the at least one primary portions 406p being inductively coupled to each of the at least one secondary portions 406s. By configuring the coupling efficiency k of the mutual inductance stage and/or the inductances of the primary and secondary portions, the signal generated at the output of the mutual inductance stage can be scaled to an appropriate magnitude for processing by subsequent signal processing stages (in this case amplification stage 408). Current mode modulation stage 404 utilises supply voltage level Vdd_mod, and amplification stage 408 utilises supply voltage level Vdd_drv. The output signal OUT of amplification stage 408 is produced at output terminal 412 across impedance 410. In embodiments, current mode modulation stage 404 includes a current mode modulator. In embodiments, amplification stage 406 includes at least one amplifier.

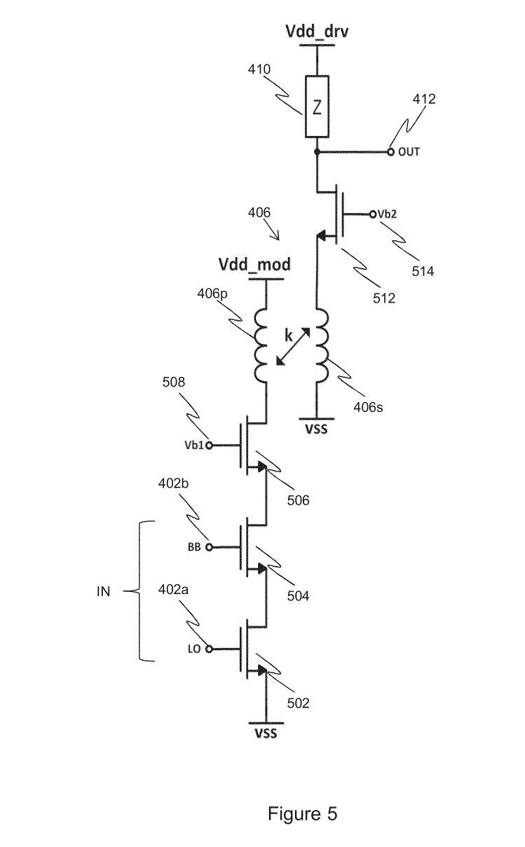

FIG. 5 illustrates schematically an example circuit layout according to the present disclosure for the topology depicted in FIG. 4. The current mode modulation stage includes a transistor cascode arrangement, including transistors 502, 504 and 506. Input signal IN, includes local oscillator input signal LO, which is applied to transistor 502 via input terminal 402a, and baseband input signal BB, which is applied to transistor 504 via input terminal 402b. Biasing voltage Vb1 is applied to transistor 506 via input terminal 508. The output of the current mode modulation stage, produced at the drain terminal of transistor 506, is applied to an input of mutual inductance stage 406. According to embodiments, mutual inductance stage 406 includes a transformer. According to embodiments, mutual inductance stage 406 includes at least two inductors that are inductively coupled. In the embodiments shown in FIG. 5, mutual inductance stage 406 includes a primary transformer winding 406p electrically connected to the output terminal of the current mode modulation stage, and a secondary transformer winding 406s electrically connected to the input terminal of the amplification stage. The primary and secondary transformer windings of mutual inductance stage 406 are inductively coupled with coupling efficiency k such that an input signal is generated at the input terminal of the amplification stage on the basis of the current mode output signal produced at the output terminal of the current mode modulation stage.

The amplification stage includes a common-gate driver arrangement, including transistor 512. Biasing voltage Vb2 is applied to transistor 512 via input terminal 514. The output signal OUT of the amplification stage is produced at output terminal 412 across impedance 410. The present disclosure further enables the use of a common-gate amplifier arrangement in the amplification stage, which is desirable due to the robust noise performance achieved by such arrangements. According to embodiments, the amplification stage has a low input impedance. Depending on the specific circuit topology, a low input impedance may comprise, for example, an input impedance of below 10 Ohms. Excluding parasitic components, the input impedance of the (common-gate) amplification stage can be expressed as the reciprocal of its transconductance. With regard to the interface at the output of the first signal processing stage (in this case the current mode modulation stage), the first stage can be considered responsible for the signal current, whilst the second signal processing stage (the amplification stage), via the mutual inductance stage, can be considered to define the impedance of the interface.

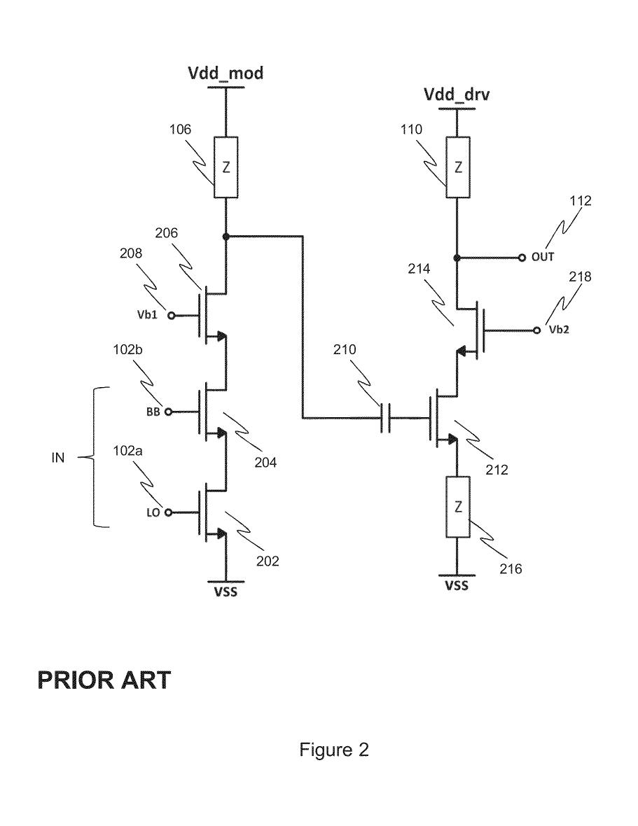

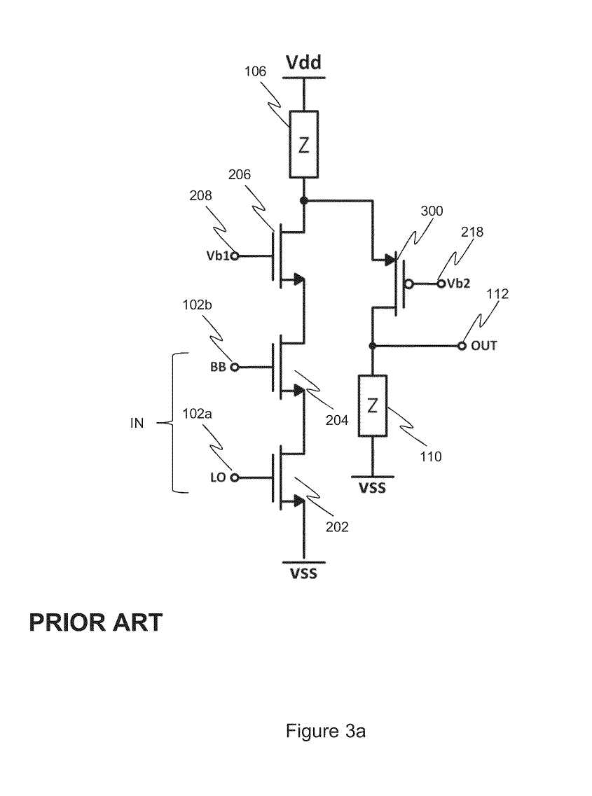

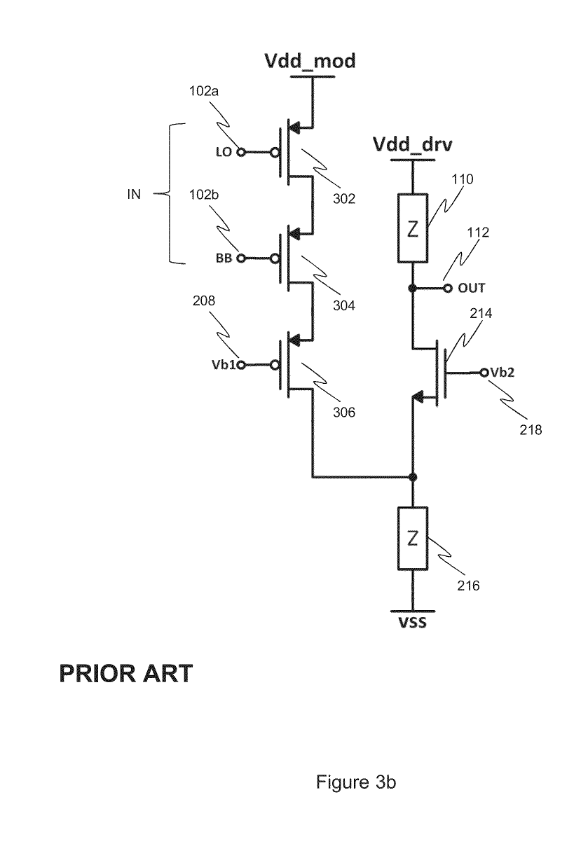

Embodiments of the present disclosure enable the supply voltage requirements of the processing system (i.e. Vdd_mod and Vdd_drv) to be reduced by decreasing the number of transistors and impedances that are required to be arranged in series compared to conventional prior arts, for example as depicted in FIG. 2. As can be seen from FIG. 5, the first signal processing stage requires three transistors (502, 504, 506) in a cascode arrangement along with the current mode interface to primary portion 406p of mutual inductance stage 406, the impedance of which is determined by the input impedance of transistor 512. In contrast, the first signal processing stage of the conventional prior art depicted in FIG. 2 requires three transistors (202, 204, 206) in a cascode arrangement along with the voltage mode interface to load impedance 106. The current mode interface to primary portion 406p of mutual inductance stage 406 has a lower voltage requirement than the voltage mode interface to load impedance 106, thereby reducing the voltage requirement of the first processing stage of the embodiments shown in FIG. 5 when compared to the conventional prior art depicted in FIG. 2. As can also be seen from FIG. 5, the second signal processing stage requires one transistor arranged in series with impedance 410 and secondary portion 406s of mutual inductance stage 406. In contrast, the second signal processing stage of the conventional prior art depicted in FIG. 2 requires two transistors arranged in series with impedance 110 and degradation impedance 216. The embodiments depicted in FIG. 5 therefore require one less transistor to be arranged in series than the conventional prior art depicted in FIG. 2 and therefore also reduce the voltage requirement of the second processing stage when compared to the conventional prior art illustrated in FIG. 2. Further, embodiments depicted in FIG. 5 do not require the use of PMOS transistor devices, and thereby avoid their associated disadvantages in relation to SNR component, size and ageing. As can be seen from the circuit schematic of FIG. 5, the teachings of the present disclosure may be applied using only NMOS transistor devices.

According to the embodiments described above, the first signal processing stage is a current mode modulation stage, and the second signal processing stage is an amplification stage. However the techniques of the present disclosure may be applied to any signal processing arrangement where a current mode output of a first signal processing stage is required to be driven into a second, subsequent signal processing stage. For example, in further embodiments the first and second signal processing stages may be sequential stages of a current mode amplifier.

In embodiments, the mutual inductance stage 406 may be configured to introduce a phase inversion between the at least one primary transformer winding 406p and the at least one secondary transformer winding 406s. Such an arrangement has the effect of introducing a phase difference of approximately 180 degrees between the current mode output signal produced at the at least one output terminal of the first signal processing stage and the input signal generated at the at least one input terminal of the second signal processing stage. This in turn serves to mitigate unwanted effects of power supply distortion by improving the power supply rejection ratio (PSRR) of the signal processing system. This is because power supply noise imposed on early signal processing stages (i.e. prior to mutual inductance stage 406) will be approximately 180 degrees out of phase with the same noise applied in later signal processing stages (i.e. subsequent to signal processing stage 406) and therefore each of the noise signals will serve to counteract each other.

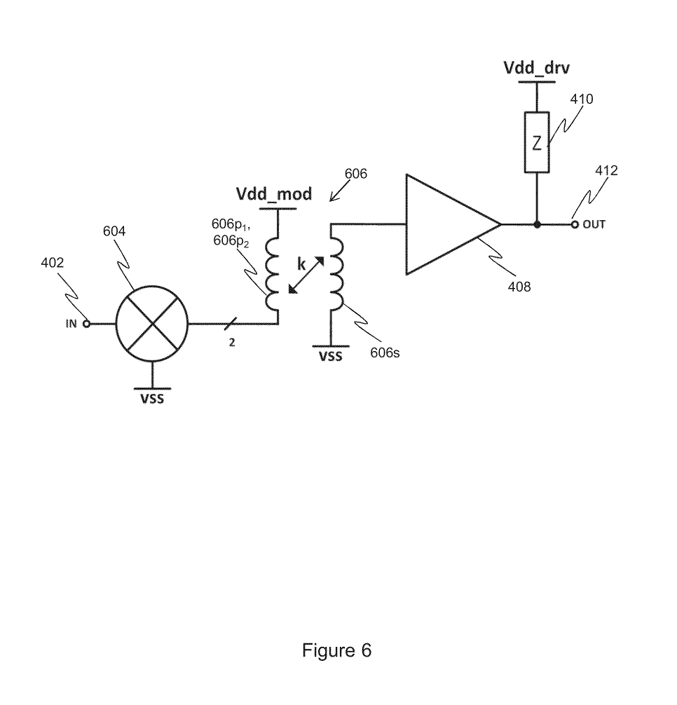

FIG. 6 shows an example circuit topology according to embodiments of the present disclosure. Input signal IN, input terminal 402, amplification stage 408, impedance 410, output signal OUT, and output terminal 412 have similar operation to the corresponding components depicted in FIG. 4. However, in the embodiments shown in FIG. 6, current mode modulation stage 604 is configured to produce a differential current-mode output signal via first and second output terminals of current mode modulation stage 604 (as opposed to the single ended current mode modulator design depicted in the previously described embodiments), as shown by the numeral “2” bisecting the output of current mode modulation stage 604. Mutual inductance stage 606 includes two primary transformer windings, 606p₁ and 606p₂. First primary transformer winding 606p₁ is electrically connected to the first output terminal of current mode modulation stage 604, and second primary transformer winding 606p₂ is electrically connected to the second output terminal of current mode modulation stage 604. Both primary transformer windings 606p₁ and 606p₂ are inductively coupled to the at least one secondary transformer winding 606s, with coupling efficiencies k₁ and k₂ respectively, such that an input signal is generated at the input terminal of amplification stage 408 on the basis of the differential current mode output signal produced at the output terminals of the current mode modulation stage. In this manner, the mutual inductance stage provides differential to single ended conversion of the signal between the first and second signal processing stages. In such embodiments, the mutual inductance stage may act as a balun.

In further embodiments, both the first signal processing stage and the second signal processing stage (i.e. the current mode modulation stage and the amplification stage respectively in the previously depicted embodiments) may be configured to process differential signals. In such embodiments, the first signal processing stage is configured to produce a differential current-mode output signal via first and second output terminals, and the second signal processing stage is configured to operate on a differential input signal via first and second input terminals of the second signal processing stage. The first output terminal of the first signal processing stage may be electrically connected to a first primary transformer winding of the mutual inductance stage, which is inductively coupled to a first secondary transformer winding of the mutual inductance stage, which is in turn electrically connected to the first input terminal of the second signal processing stage. Similarly, the second output terminal of the first signal processing stage may be electrically connected to a second primary transformer winding of the mutual inductance stage, which is inductively coupled to a second secondary transformer winding of the mutual inductance stage, which is in turn electrically connected to the second input terminal of the second signal processing stage. In this manner, the mutual inductance stage provides differential to differential coupling of the signal between the first and second signal processing stages.

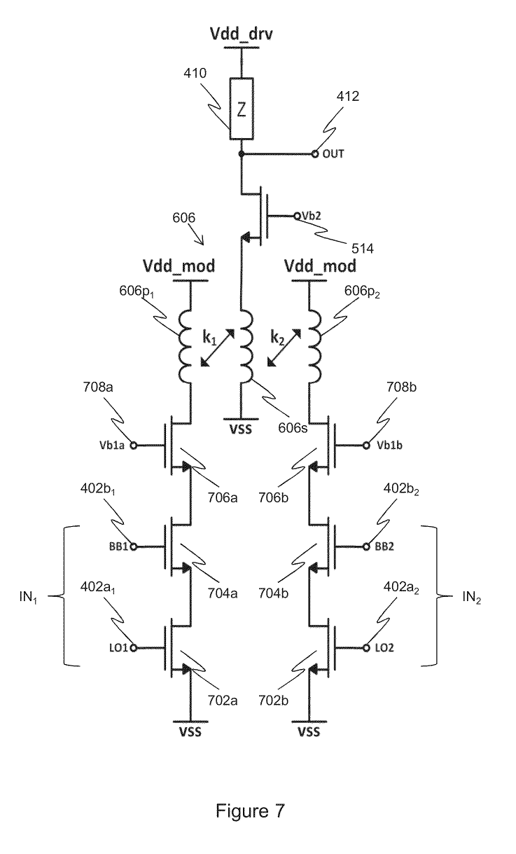

FIG. 7 illustrates schematically an example circuit layout according to the present disclosure for the topology depicted in FIG. 6. Impedance 410, output signal OUT, output terminal 412, transistor 512 and bias voltage Vb2 and input terminal 514 have similar operation to the corresponding components depicted in FIGS. 4 and 5. However, in the embodiments depicted in FIG. 7, the current mode modulation stage is configured to produce a differential output through the use of a first cascode arrangement, including transistors 702a, 704a, and 706a, and a second cascode arrangement, including transistors 702b, 704b, and 706b. Input signal IN, includes first input signal portion IN₁ applied to the first cascode arrangement, and second input signal portion IN₂ applied to the second cascode arrangement. First input signal portion IN₁ includes first local oscillator input signal LO₁ which is applied to transistor 702a via input terminal 402a₁, and first baseband input signal BB₁ which is applied to transistor 704a via input terminal 402b₁. Biasing voltage Vb1a is applied to transistor 706a via input terminal 708a. Second input signal portion IN₂ includes second local oscillator input signal LO₂ which is applied to transistor 702b via input terminal 402a₂, and first baseband input signal BB₂ which is applied to transistor 704b via input terminal 402b₂. Biasing voltage Vb1b is applied to transistor 706b via input terminal 708b.

The output of the first cascode arrangement forms the first differential output of the current mode modulation stage, and is applied to the first primary transformer winding 606p₁ of mutual inductance stage 606. The output of the second cascode arrangement forms the second differential output of the current mode modulation stage and is applied to the second primary transformer winding 606p₂ of mutual inductance stage 606. The first and second primary transformer windings are inductively coupled to the secondary transformer winding 606s of mutual inductance stage 606 with coupling efficiencies k₁ and k₂ respectively. The result of these inductive couplings is that a signal is generated across the secondary transformer winding of mutual inductance stage 606 on the basis of the differential current mode output signal of the current mode modulation stage. The secondary transformer winding is electrically connected to the amplification stage, thereby providing an input to the amplification stage.

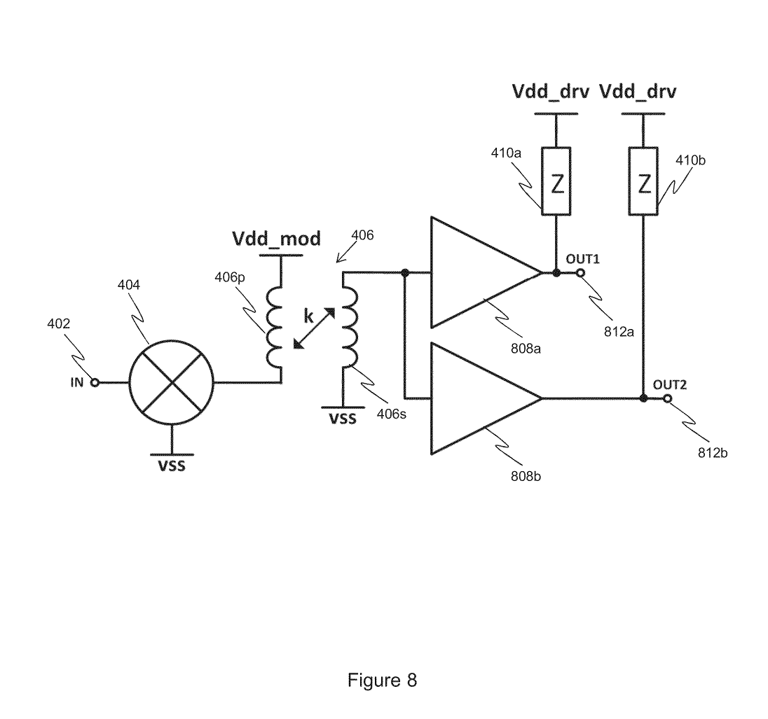

FIG. 8 shows an example circuit topology according to embodiments of the present disclosure wherein the amplification stage may include a plurality of parallel amplification stages. In the embodiments shown in FIG. 8, input signal IN, input terminal 402, current mode modulation stage 404, mutual inductance stage 406, output signal OUT, and output terminal 412 have similar operation to the corresponding components depicted in FIG. 4. However, the output of the mutual inductance stage is electrically connected to the inputs of a plurality of parallel amplification stages, including a first amplification stage 808a and a second amplification stage 808b. The operations of first amplification stage 808a and second amplification stage 808b are each equivalent to amplification stage 408 as described in relation to FIG. 4. The output OUT1 of amplification stage 808a is generated across impedance 810a at output terminal 812a. The output OUT2 of amplification stage 808b is generated across impedance 810b at output terminal 812b. The outputs of the various amplification stages in the plurality of parallel amplification stages may be used for supplying signals to different power amplifiers, filter units or antennas, for example for diversity or multiband applications. In embodiments, each of the parallel amplification stages may be designed to meet different out-of-chip requirements. While FIG. 8 depicts an amplification stage that includes two parallel amplification stages, in further embodiments, more than two parallel amplification stages are included in an analogous manner. In embodiments, each of the parallel amplification stages includes at least one amplifier.

In order to improve the isolation between the parallel amplification stages, in embodiments, a mutual inductance stage may be provided that includes a plurality of secondary transformer windings. In such embodiments, each secondary transformer winding in the plurality of secondary transformer windings is electrically connected to a different parallel amplification stage in the plurality of parallel amplification stages. By providing a plurality of secondary transformer windings, each secondary transformer winding may be designed for a given frequency or range of frequencies.

In embodiments, a multiplexing arrangement is provided between the plurality of secondary transformer windings and the parallel amplification stages in order to electrically connect each of the secondary transformer windings in the plurality of secondary transformer windings to one or more of the parallel amplification stages. In this manner, any combination of different outputs may be provided for different frequency ranges, designed for different out-of-chip requirements. For example, depending on circuit requirements, the multiplexing arrangement may be arranged to electrically connect a first secondary transformer winding to a first parallel amplification stage, and to electrically connect a second secondary transformer winding to three further parallel amplification stages (e.g. to provide three distinct outputs with the same frequency design and one additional output with a different frequency design).

In some embodiments, a mutual inductance stage is provided with both a plurality of primary transformer windings (in order to facilitate a differential output from the first signal processing stage) and a plurality of secondary transformer windings (in order to provide improved isolation between a plurality of parallel amplification stages).

In embodiments, the mutual inductance stage may include a plurality of interleaved coils. One way of fabricating such a mutual inductance may include the use of substantially planar tracks. Such tracks may be printed on a circuit board or similar structure.

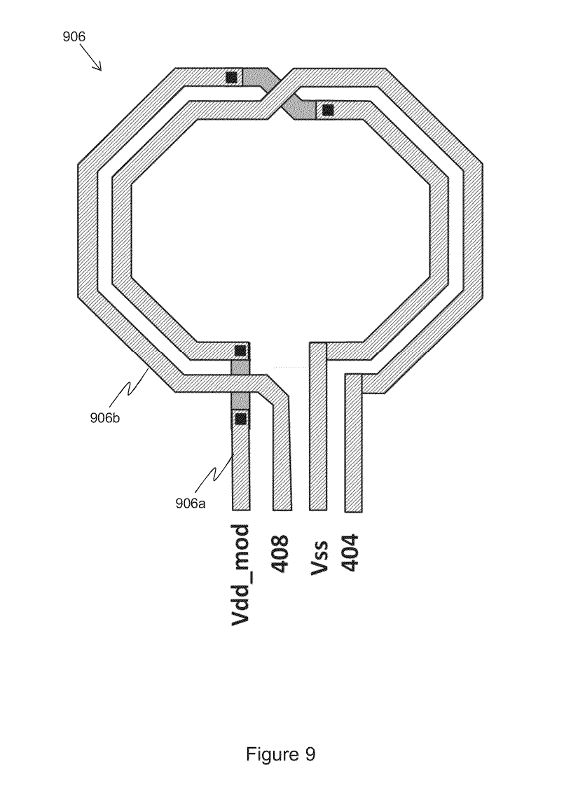

FIG. 9 shows a mutual inductance stage 906 according to embodiments of the present disclosure. Mutual inductance stage 906 includes two interleaved coils that are each formed from one full turn (i.e. omitting the terminal portions, turns approximately 360 degrees on a plane from one end to the other). A first coil 906a is electrically connected to an output terminal of current mode modulation stage 404 and the positive voltage supply terminal of the current mode modulation stage circuit, Vdd_mod, thereby forming a primary transformer winding of mutual inductance stage 906. A second coil 906b is electrically connected to an input terminal of amplification stage 408 and the negative voltage supply terminal, thereby forming a secondary transformer winding of mutual inductance stage 906. The majority of the tracks shown in FIG. 9 are co-planar, as shown by the hatched shading. However, in order to prevent electrical connection between the primary and secondary tracks, one of the tracks is routed via a second, different plane at the points of overlap, as shown by the block shading. This may be along the reverse of a printed circuit board, or some other different planar height. While mutual inductance stage 906 includes two interleaved coils, further interleaved coils may be added, e.g. through the addition of a further concentric track, in order to add a further primary or secondary transformer winding to the mutual inductance stage.

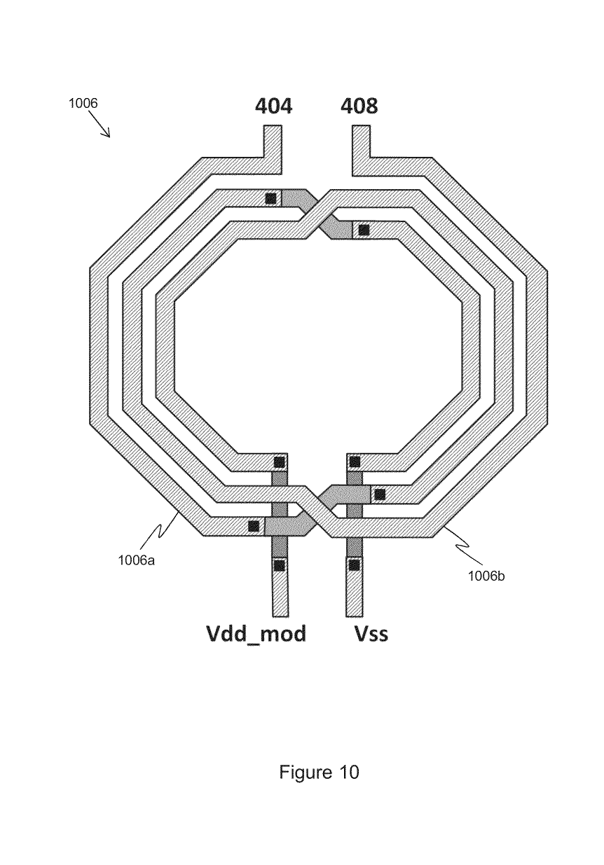

FIG. 10 shows a further mutual inductance stage 1006 according to embodiments of the present disclosure. Mutual inductance stage 1006 includes two interleaved coils that are each formed from one and a half turns (i.e. omitting the terminal portions, turns approximately 540 degrees on a plane from one end to the other). A first coil 1006a is electrically connected to an output terminal of current mode modulation stage 404 and the positive voltage supply terminal of the current mode modulation stage circuit, Vdd_mod, thereby forming a primary transformer winding of mutual inductance stage 1006. A second coil 1006b is electrically connected to an input terminal of amplification stage 408 and the negative voltage supply terminal Vss, thereby forming a secondary transformer winding of mutual inductance stage 1006. The majority of the tracks shown in FIG. 10 are co-planar, as shown by the wide hatched shading. However, in order to prevent electrical connection between the primary and secondary tracks, one or more of the tracks is routed via a second and or a third, different plane at the points of overlap, as shown by the block shading and the narrow hatched shading. While mutual inductance stage 1006 includes two interleaved coils, further interleaved coils may be added, e.g. through the addition of a further concentric track, in order to add a further primary or secondary transformer winding to the mutual inductance stage.

While the embodiments described above have described the apparatus of the present disclosure in terms of a circuit, further embodiments include the disclosure as applied to a transmitter, a front end module, a radio frequency integrated circuit (RFIC), a chipset, and a user equipment.

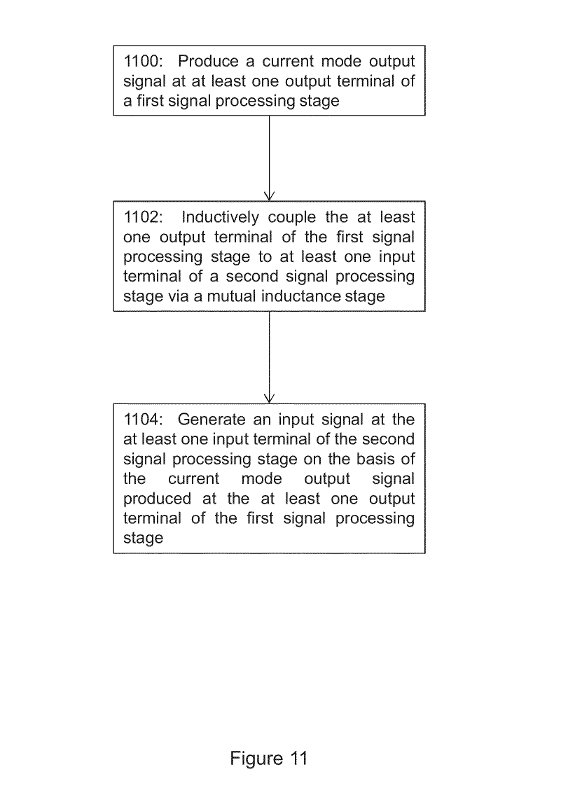

FIG. 11 shows a logic flow diagram illustrating a method according to embodiments of the present disclosure. At step 1100, a current mode output signal is produced at least one output terminal of a first signal processing stage. At step 1102, the at least one output terminal of the first signal processing stage is inductively coupled to at least one input terminal of a second signal processing stage via a mutual inductance stage. At step 1104, an input signal is generated at the at least one input terminal of the second signal processing stage on the basis of the current mode output signal produced at the at least one output terminal of the first signal processing stage.

Further embodiments relate to methods of manufacturing such apparatus by providing a first signal processing stage comprising at least one output terminal, the first signal processing stage being configured to produce a current mode output signal via the at least one output terminal; providing a second signal processing stage comprising at least one input terminal; and providing a mutual inductance stage, arranged to inductively couple the at least one output terminal of the first signal processing stage to the at least one input terminal of the second signal processing stage, wherein an input signal is generated at the at least one input terminal of the second signal processing stage on the basis of the current mode output signal produced at the at least one output terminal of the first signal processing stage. Such a method of manufacture may, for example, include a circuit fabrication method, for the manufacture of integrated circuits, printed circuits or similar.

The above embodiments are to be understood as illustrative examples of the invention. Further embodiments of the invention are envisaged. For example, while the embodiments described above have been in the context of a transmitter system, the disclosure may be similarly applied to other signal processing applications where current mode signals are used. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus arranged to process a current mode signal in a radio frequency transmitter, the apparatus comprising:
a first signal processing stage comprising at least one output terminal, the first signal processing stage being configured to produce a current mode output signal at the at least one output terminal;
a second signal processing stage comprising at least one input terminal; and
a mutual inductance stage, arranged to inductively couple the at least one output terminal of the first signal processing stage to the at least one input terminal of the second signal processing stage,
wherein an input signal is generated at the at least one input terminal of the second signal processing stage on the basis of the current mode output signal produced at the at least one output terminal of the first signal processing stage.

2. The apparatus according to claim 1, wherein the at least one input terminal of the second signal processing stage comprises a low input impedance.

3. The apparatus according to claim 1, wherein the first signal processing stage comprises a current mode modulator.

4. The apparatus according to claim 1, wherein the first and second signal processing stages comprise sequential stages of a current mode amplifier.

5. The apparatus according to claim 1, wherein the first signal processing stage comprises a cascode amplifier arrangement.

6. The apparatus according to claim 1, wherein the second signal processing stage comprises one or more amplifiers, wherein at least one of the one or more amplifiers comprises a common gate amplifier arrangement.

7. (canceled)

8. The apparatus according to claim 1, wherein the mutual inductance stage comprises at least one transformer, wherein the mutual inductance stage comprises one of:
at least two inductors that are inductively coupled, and
a plurality of interleaved coils.

9-10. (canceled)

11. The apparatus according to claim 8, wherein at least one coil in the plurality of interleaved coils comprises at least one of:
a substantially planar track,
a full turn, and
one and a half turns.

12-13. (canceled)

14. The apparatus according to claim 1, wherein the mutual inductance stage comprises at least one primary transformer winding electrically connected to the at least one output terminal of the first signal processing stage and at least one secondary transformer winding electrically connected to the at least one input terminal of the second signal processing stage, wherein the mutual inductance stage is configured to provide a phase inversion between the at least one primary transformer winding and the at least one secondary transformer winding.

15. (canceled)

16. The apparatus according to claim 1, wherein the first signal processing stage is configured to produce a single-ended current mode output signal via the at least one output terminal of the first signal processing stage.

17. The apparatus according to claim 14, wherein the first signal processing stage comprises a first output terminal electrically connected to a first primary transformer winding of the mutual inductance and a second output terminal electrically connected to a second primary transformer winding of the mutual inductance,
wherein the first signal processing stage is configured to produce a differential current mode output signal at the first and second output terminals of the first signal processing stage.

18. The apparatus according to claim 17, wherein the first primary transformer winding and the second primary transformer winding are each inductively coupled to the at least one secondary transformer winding of the mutual inductance, and
wherein the second signal processing stage is configured to operate on a single ended input signal at the at least one input terminal of the second signal processing stage.

19. The apparatus according to claim 17, wherein the second signal processing stage comprises a first input terminal electrically connected to a first secondary transformer winding of the mutual inductance and a second input terminal electrically connected to a second secondary transformer winding of the mutual inductance,
wherein the first primary transformer winding of the mutual inductance is inductively coupled to the first secondary transformer winding of the mutual inductance,
wherein the second primary transformer winding of the mutual inductance is inductively coupled to the second secondary transformer winding of the mutual inductance, and
wherein the second signal processing stage is configured to operate on a differential input signal at the at least first and second input terminals of the second signal processing stage.

20. The apparatus according to claim 1, wherein the second signal processing stage comprises a plurality of parallel amplification stages, wherein each amplification stage in the plurality of parallel amplification stages is electrically connected to at least one secondary transformer winding of the mutual inductance stage.

21. (canceled)

22. The apparatus according to claim 21, wherein the mutual inductance stage comprises a plurality of secondary transformer windings, each secondary transformer winding in the plurality of secondary transformer windings being electrically connected to a different parallel amplification stage in the plurality of parallel amplification stages.

23. The apparatus according to claim 21, wherein each amplification stage in the plurality of parallel amplification stages is electrically connected to the same secondary transformer winding of the mutual inductance stage.

24. The apparatus according to claim 21, comprising a multiplexing arrangement, wherein the mutual inductance stage comprises a plurality of secondary transformer windings, the multiplexing arrangement being adapted to electrically connect each secondary transformer winding in the plurality of secondary transformer windings to one or more parallel amplification stages in the plurality of parallel amplification stages.

25. The apparatus according to claim 1, wherein the apparatus comprises one or more of:
a circuit,
a transmitter,
a front end module,
a radio frequency integrated circuit (RFIC),
a chipset, and
a user equipment.

26. A method of processing a current mode signal in a radio frequency transmitter, the method comprising:
producing a current mode output signal at least one output terminal of a first signal processing stage;
inductively coupling the at least one output terminal of the first signal processing stage to at least one input terminal of a second signal processing stage via a mutual inductance stage; and
generating an input signal at the at least one input terminal of the second signal processing stage on the basis of the current mode output signal produced at the at least one output terminal of the first signal processing stage.

27. A method of manufacturing an apparatus arranged to process a current mode signal in a radio frequency transmitter, the method comprising:
providing a first signal processing stage comprising at least one output terminal, the first signal processing stage being configured to produce a current mode output signal via the at least one output terminal;
providing a second signal processing stage comprising at least one input terminal; and
providing a mutual inductance stage, arranged to inductively couple the at least one output terminal of the first signal processing stage to the at least one input terminal of the second signal processing stage,
wherein an input signal is generated at the at least one input terminal of the second signal processing stage on the basis of the current mode output signal produced at the at least one output terminal of the first signal processing stage.

28. (canceled)
